(19) United States
(12) Patent Application Publication
(10) Pub. No.: US 2010/0328036 A1
(43) Pub. Date: Dec. 30, 2010

(54) SECURITY SYSTEM AND METHOD FOR GRANTING ACCESS

(75) Inventor: KUI-JUN WANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (TW); HON HAI PRECISION INDUSTRY CO., LTD., Tu-Cheng (TW)

(21) Appl. No.: 12/647,398

(22) Filed: Dec. 25, 2009

(30) Foreign Application Priority Data
Jun. 25, 2009 (CN) 200910303667.8

(51) Int. Cl. H04L 9/32

(52) U.S. Cl. 340/5.85

(57) ABSTRACT

A method for granting access to change a security system from a locked state to an unlocked state includes: displaying a security access interface on the display unit; selecting one image; changing at least one value of at least one property of the selected image; at least recording the at least one changed value of the at least one property of the selected image; generating an input password at least according to the at least one recorded value of the at least one property of the selected; determining whether the input password matches a predetermined password; and granting access if the input password matches with the predetermined password. A related security system is also provided.

### BACKGROUND

1. Technical Field

The present disclosure relates to security systems, and more particularly to a security system and a method for granting access used by the security system.

2. Description of Related Art

A conventional password often includes numerical numbers and/or letters, such as, 0-9, and a-z/A-Z. However, input devices used for inputting password information are substantially similar, and locations of the numbers and the letters arranged in the input device are almost uniform and common. Accordingly, passwords can easily be figured out merely by observing how they are input.

### BRIEF DESCRIPTION OF THE DRAWINGS

The components of the drawings are not necessarily drawn to scale, the emphasis instead being placed upon clearly illustrating the principles of a security system and a method for granting access. Moreover, in the drawings, like reference numerals designate corresponding parts throughout several views.

FIG. 1 is a block diagram of a security system in accordance with an exemplary embodiment.

FIG. 2 is a schematic diagram showing a security access interface generated by the security system of FIG. 1.

FIG. 3 is a schematic diagram showing a plurality of storage names of images displayed on the security access interface of FIG. 2.

FIG. 4 is a schematic diagram showing one selected image displayed on the security access interface of FIG. 2.

FIG. 5 is a schematic diagram of showing the value of one property of the selected image of FIG. 4 changed.

FIG. 6 is a flowchart of a method for granting access in accordance with an embodiment.

### DETAILED DESCRIPTION

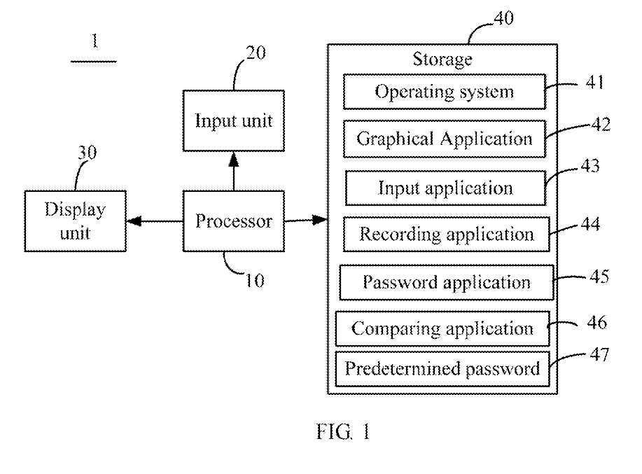

Referring to FIG. 1, a block diagram of a security system 1 in accordance with an exemplary embodiment is shown. The system 1 generally includes a processor 10, an input unit 20, a display unit 30, and a storage 40.

The processor 10 executes/runs various software components stored in the storage 40 to perform various functions for the security system 1, and controls the operations of the security system 1.

The input unit 20 is configured to generate instructions in response to user inputs. In the embodiment, the input unit 20 includes at least one physical button. In an alternative embodiment, the input unit 20 can be a touch pad.

The display unit 30 is configured to output graphical data. The visual outputs may include text, graphic, video, and any combination thereof. The display unit 30 can be a touch sensitive display unit.

The storage 40 stores an operating system 41, a graphical application 42, an input application 43, a recording application 44, a password application 45, a comparing application 46, and a predetermined password 47 used for authenticating an inputted password.

The operating system 41 (e.g., LINUX®, UNIX®, WINDOWS®, or an embedded operating system 41 such as VxWorks®) includes various procedures, sets of instructions, software components and/or drivers for controlling and managing general system tasks (e.g., memory management, storage control, and power management, etc.) and facilitating communication between various hardware and software components.

The graphical application 42 includes various software components and/or set of instructions, which may be implemented by the processor 10 for rendering and displaying graphical user interfaces (GUI) on the display unit 30. It should be noted that the GUI can include any object that can be displayed, including, text, web pages, digital images, videos, animations and the like.

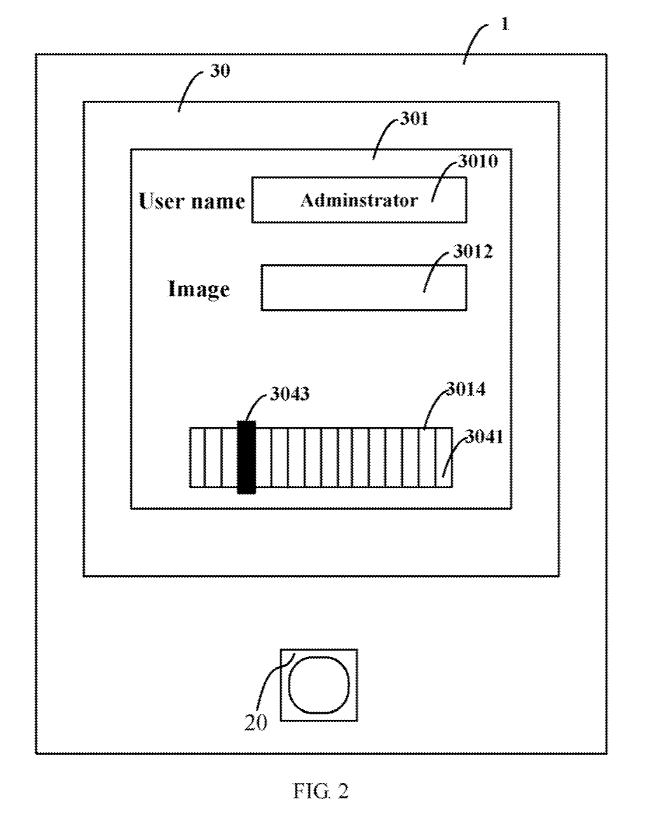

Referring also to FIG. 2, when the system 1 is triggered to prompt for accessing/unlock operations (procedures), the graphical application 42 is implemented by the processor 10 to display a security access interface 301 on the display unit 30. The interface 301 includes a user name input field 3010, an image input field 3012, and at least one property control bar 3014. The user name input field 3010 is configured for a user to input one user name. The image input field 3012 is configured for the user to select one image. The bar 3014 is configured for changing the value of one property of the selected image for example a color property, a resolution property, or a brightness property. In the embodiment, one bar 3014 is employed. The property is the resolution property, as an example. The bar 3014 is divided into a plurality of property cells 3041. Each cell 3041 corresponds to a value of the property. A pointer 3043 is displayed on the bar 3014 for selecting one property value. When the pointer 3043 stays on one cell 3041 for a predetermined amount of time, the value of the property is changed to the value corresponding to the selected cell 3041. In an alternative embodiment, a plurality of bars 3014 can be employed.

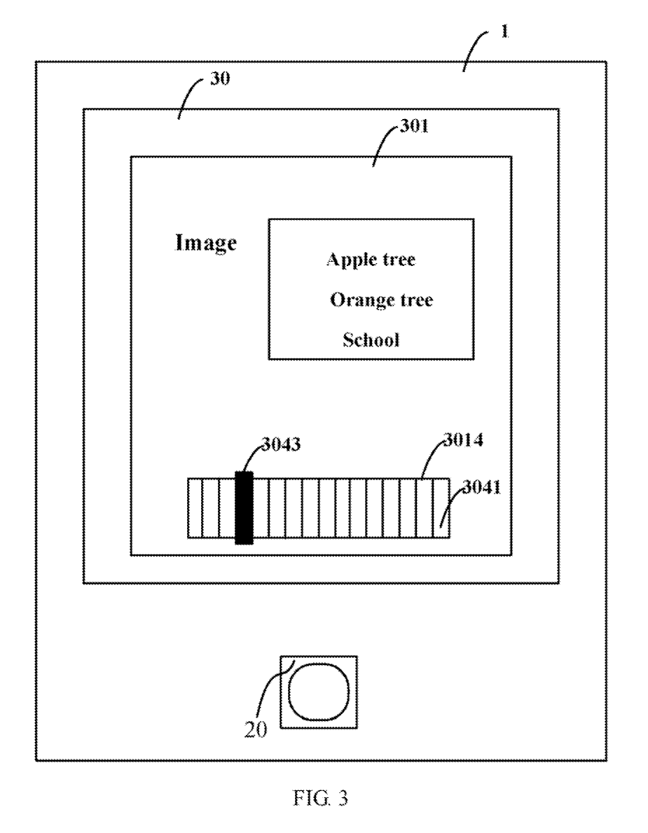

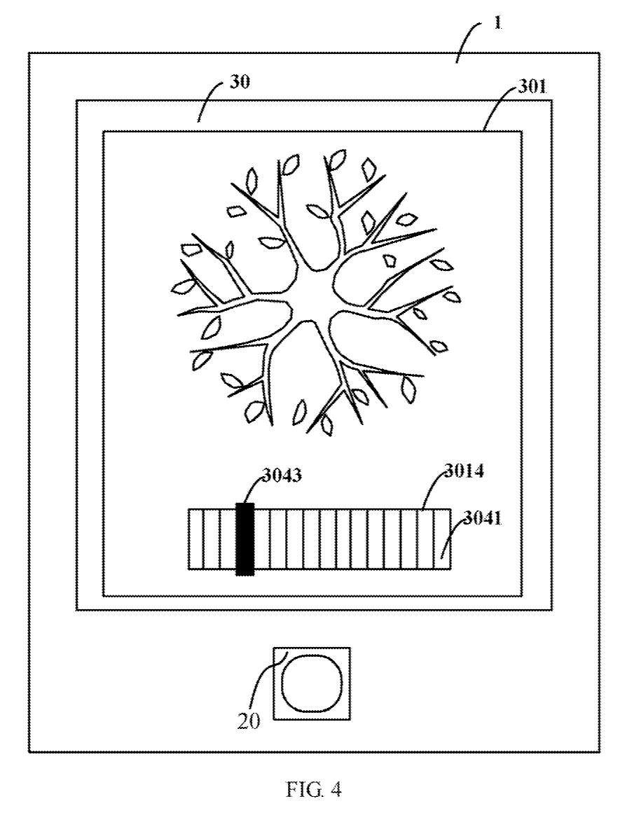

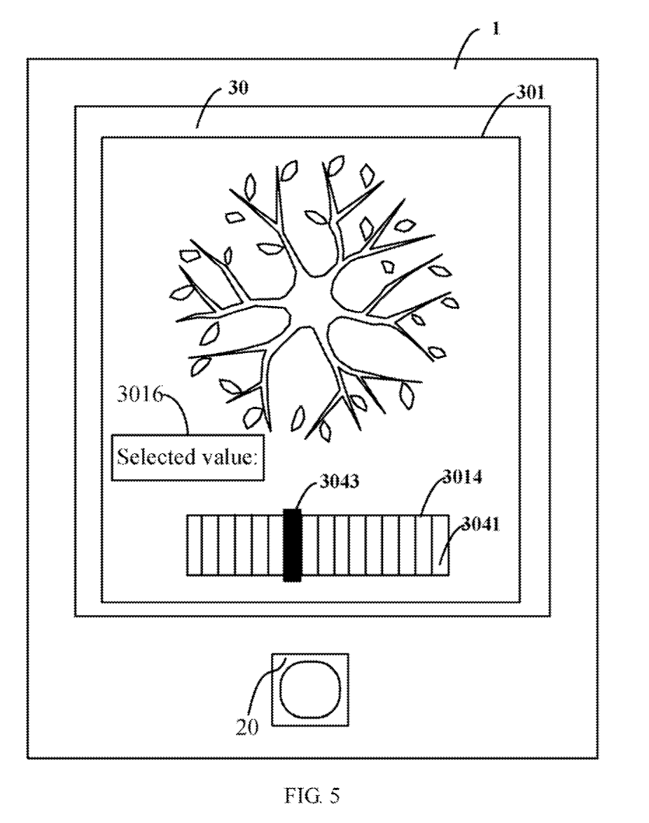

As shown in FIG. 3, when the image input field 3012 is triggered, a plurality of storage names of images for example Apple tree, Orange tree, and School, is displayed on the interface 301 for the user to select one image. As shown in FIG. 4, when the user selects one of the images, the selected image is displayed on the display unit 30. As shown in FIG. 5, when the selected image is displayed, the user can move the pointer 3043 to change the value of the property of the selected image. In the embodiment, when the pointer 3043 stays on one cell 3041 for the predetermined time, a property prompt 3016 is displayed on the display 30 for informing the user of the selected value of the property.

In an alternative embodiment, when the image input field 3012 is triggered, a plurality of thumbnail images is displayed on the interface 301 for the user to select.

The input application 43 includes various software components and/or set of instructions, which can be invoked/implemented by the processor 10 for receiving instructions from the input unit 20, and performing various functions for example selecting one image and changing the value of the property of the selected image according to the received instructions.

The recording application 44 includes various software components and/or set of instructions, which can be invoked/implemented by the processor 10 for recording the changed value of the property of the selected image, the storage name of the selected image, the storage path of the selected image, and so on.

The password application 45 includes various software components and/or set of instructions, which can be invoked/implemented by the processor 10 for generating an input password at least according to the recorded value of the property of the selected image. In the embodiment, the password application 45 is invoked/implemented by the processor 10 to generate the input password according to the recorded value of the property of the selected image. In an alternative embodiment, the password application 45 is invoked/implemented by the processor 10 to generate the input password according to the recorded value of the property of the selected image, the storage name of the selected image, and the storage path of the selected image. In the embodiment, when a confirm instruction is received from the input unit 20, the password application 45 is invoked/implemented by the processor 10 to generate the input password.

Furthermore, the input password can be defined as a newly predetermined password to replace the previously predetermined password 47 stored in the storage 40.

The comparing application 46 includes various software components and/or set of instructions, which can be invoked/implemented by the processor 10 for comparing the input password with the predetermined password 47. When the input password matches the predetermined password, the security system 1 is unlocked. Otherwise, the security system 1 remains locked.

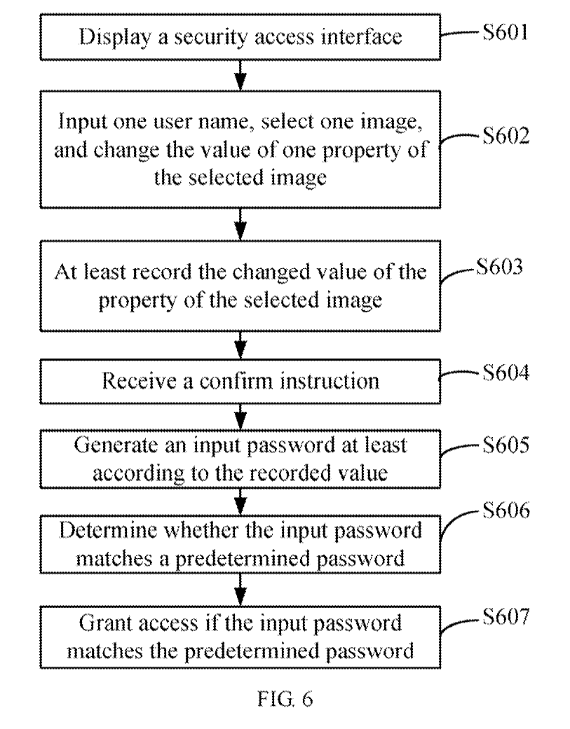

Referring to FIG. 6, a flowchart illustrating a method used by the security system 1 of FIG. 1 for granting access is shown. The method includes the following steps, each of which is tied to various modules contained in the security system 1 as shown in FIG. 1.

In step S601, in operation, the processor 10 invokes/implements the graphical application 42 to display the security access interface 301 on the display unit 30. In the embodiment, the interface 301 includes the user name input field 3010, the image input filed 3012, and the property control bar 3014.

In step S602, the processor 10 invokes/implements the input application 43 to receive user instructions from the input unit 20, thereby, inputting one user name, selecting one image, and change the value of the property via moving the pointer 3043.

In step S603, the processor 10 invokes/implements the recording application 44 to at least record the changed value of the property of the selected image. In an alternative embodiment, the recording application 44 can further be invoked/implemented to record the storage name of the selected image and the storage path of the selected image.

In step S604, the processor 10 invokes/implements the input application 43 to determine whether a confirm instruction is received from the input unit 20.

In step S605, if the confirm instruction is received, the processor 10 invokes/implements the password application 45 to generate an input password at least according to the recorded value of the property of the selected image. In an alternative embodiment, the password application 45 is invoked/implemented to generate the input password according to the recorded value of the property of the selected image, the storage name of the selected image, and the storage path of the selected image.

In step S606, the processor 10 invokes/implements the comparing application 46 to determine whether the input password matches the predetermined password 47 in the storage 40.

In step S607, the processor 10 triggers the security system 1 to grant access/unlock operations (procedures) if the input password matches the predetermined password 47.

As described above, the user is granted access by selecting one image and changing the value of at least one property of the selected image, thereby, protecting the password more safely and efficiently as it cannot be easily determined by mere observation since fixed patterns of input options are not being displayed.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A security system comprising:
a display unit;
an input unit configured for generating instructions in relation to user input;
a storage storing a predetermined password and a plurality of modules; and
a processor executing the plurality of modules;
wherein the plurality of modules comprises instructions executable by the processor to:
display a security access interface on the display unit, wherein the security access interface comprises an image input field and at least one property control bar, the image input field is configured for selecting one image, each of the at least one property control bar is configured for controlling the value of one property of one selected image;
select one image and change at least one value of at least one property of the selected image according to the received instructions from the input unit;
at least record the at least one changed value of the at least one property of the selected image;
generate an input password at least according to the at least one recorded value of the at least one property of the selected image;
determine whether the input password matches the predetermined password; and
grant access if the input password matches the predetermined password.

2. The security system as described in claim 1, wherein the plurality of modules further comprises instructions executable by the processor to record the storage name of the selected image.

3. The security system as described in claim 2, wherein the plurality of modules further comprises instructions executable by the processor to record the storage path of the selected image.

4. The security system as described in claim 2, wherein the plurality of modules further comprises instructions executable by the processor to generate the input password further according to the storage name of the selected image.

5. The security system as described in claim 3, wherein the plurality of modules further comprises instructions executable by the processor to generate the input password further according to the storage path of the selected image.

6. The security system as described in claim 3, wherein the plurality of modules further comprises instructions executable by the processor to generate the input password further according to the storage name of the selected image and the storage path of the selected image.

7. The security system as described in claim 1, wherein the plurality of modules further comprises instructions executable by the processor to:
determine whether a confirm instruction is received; and
generate the input password if the confirm instruction is received.

8. The security system as described in claim 1, wherein the plurality of modules further comprises instructions executable by the processor to:
keep the security system in a locked state if the input password does not match the predetermined password.

9. A method for granting access to change a security system from a locked state to an unlocked state, the method comprising:
displaying a security access interface on the display unit, wherein the security access interface comprises an image input field and at least one property control bar, the image input field is configured for selecting one image, each of the at least one property control bar is configured for changing at least one value of at least one property of one selected image;
selecting one image;
changing the at least one value of the at least one property of the selected image;
at least recording the at least one changed value of the at least one property of the selected image;
generating an input password at least according to the at least one recorded value of the at least one property of the selected;
determining whether the input password matches a predetermined password; and
granting access if the input password matches the predetermined password.

10. The method as described in claim 9 further comprising: recording the storage name of the selected image.

11. The method as described in claim 10 further comprising: recording the storage path of the selected image.

12. The method as described in claim 10, wherein generating an input password at least according to the at least one recorded value of the at least one property of the selected image further comprises: generating the input password further according to the storage name of the selected image.

13. The method as described in claim 11, wherein generating an input password at least according to the at least one recorded value of the at least one property of the selected image further comprises: generating the input password further according to the storage path of the selected image.

14. The method as described in claim 11, wherein generating an input password at least according to the at least one recorded value of the at least one property of the selected image further comprises: generating the input password further according to the storage name of the selected image and the storage path of the selected image.

15. The method as described in claim 9, further comprising:
determining whether a confirm instruction is received; and
generating the input password if the confirm instruction is received.

16. The method as described in claim 9, further comprising:
keeping the security system in the locked state if the input password does not match the predetermined password.
